(19) United States
(12) Patent Application Publication
(10) Pub. No.: US 2004/0206852 A1
(43) Pub. Date: Oct. 21, 2004

(54) Aerodynamic profile

(76) Inventor: Manuel Munoz Saiz, Almeria (ES)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/603,962

(22) Filed: Jun. 25, 2003

(30) Foreign Application Priority Data
Apr. 16, 2003 (ES) P200301012

(51) Int. Cl. B64C 27/22

(52) U.S. Cl. 244/10

(57) ABSTRACT

Aerodynamic profile that comprises two zones or main sections: one is the front surface inclined with a positive angle, generating the totality or greater part of the lift, and the other is the rear portion or zone to the front surface, profiled or streamlined, formed by two curved, generally hollow surfaces and, which does not generate lift, but leads the air flow properly reducing drag and avoiding boundary layer separation.

### CROSS REFERENCE TO RELATED APPLICATIONS

This application claims the priority date of Spanish Patent P200301012 filed on Apr. 16, 2003. The basis for priority in this case is the Paris Convention for the Protection of Industrial Property (613 O.G. 23,53 Stat 1748). The Spanish patent application was filed in The Official Patent and Trademarks Office of Spain.

### FIELD OF THE INVENTION

In all types of vehicles and their external elements such as wings, fuselages, horizontal and vertical stabilizers, engines, etc. of the aircraft.

### STATE OF THE PRIOR ART

Existing aerodynamic profiles have a transversal cross-section with a rounded leading edge which is partially elliptical or oval, with the trailing edge in a very acute dihedral angle, the upper surface being convex and the lower surface substantially flat, and with a relatively low lift/drag ratio. Such aerodynamic profiles produce lift as a function of the pressure differences generated between the upper and lower surfaces, which are negative on the upper surface and positive on the lower surface.

### DESCRIPTION OF THE INVENTION

The aerodynamic profile of the invention consists of two zones or main sections. One is the front surface inclined with a positive angle, generating the totality or greater part of the lift, and the other is the rear portion or zone to the front surface, profiled or streamlined, formed by two curved, generally hollow surfaces which do not generate lift, but lead the air flow, properly reducing drag and avoiding boundary layer separation. The aerodynamic profile of the invention can be considered like an inclined plate whose rear surface is streamlined, taking advantage of its lifting frontal characteristics and eliminating the drawback or disadvantages such as drag or boundary layer separation of the rear zone of the plate.

The aerodynamic profile produces a great lift with minimum drag providing maximum efficiency and effectiveness, with the separation between the two surfaces of the rear portion determining its efficiency. There is no depression in the upper surface, which prevents the occurrence of boundary layer separation, eliminating the difficulty resulting from great angles of attack of the existing wings.

The inclined front surface can be flat, concave or convex.

The nose or leading edge upper zone can be slightly curved.

The nose or leading edge can be rounded, allowing greater angles of attack.

The rear portion can have its lower surface flat, horizontal and rigid, in this case said zone will produce lift due to its downward inclination. It can have also different intermediate inclinations from the later portion between this last inclination and the horizontal.

The periphery of the front surface can display a small flange except in its lower zone, which projects and avoids the slip of the air, and with whose flow is aligned, which is specially useful with profiles arranged longitudinally.

The front surface can be circular, oval or rectangular with its corners rounded, and when they are longitudinal elements, they can be arranged laterally, vertical or inclined. In all the cases its efficiency is the same.

The rear portion can be rigid, can be total or partially free and rotary and can also be driven by means of a ram. It can have flexible walls or it can be formed by two flexible plates which slide between themselves in the trailing edge, in which they adapt to the airflow independently of the angle of attack applied.

It is useful for all type of vehicles and their external elements such as wings, fuselages, horizontal and vertical stabilizers, engines, etc. of the aircraft.

Unlike the existing wings, this profile produces great lift with zero angle of attack and without separation of the boundary layer. In an aircraft, it can be enough with narrow and transversally lengthened stabilizing wings.

Advantages: It is simple and inexpensive, it can completely eliminate or significantly reduce the disadvantages resulting from wing use, the boundary layer separation is eliminated or minimized, and it has high efficiency and saves fuel. In addition, the lift/drag rate is very large and it allows greater angles of attack of the front surface.

### BRIEF DESCRIPTION OF THE DRAWINGS

FIG. 1 shows a schematic and cross-section view of the profile of the invention.

FIG. 2 shows a perspective view of a variant of a profile.

FIG. 3 shows a schematic and cross-section view of a variant of the profile of the invention.

FIG. 4 shows a schematic and cross-section view of a variant of the profile of the invention.

FIG. 5 shows a schematic and cross-section view of a variant of the profile of the invention.

FIG. 6 shows a schematic front and partial view of a variant of the profile of the invention.

FIG. 7 shows a schematic front view of a variant of the profile of the invention.

FIG. 8 shows a schematic front and partial view of a variant of the profile of the invention.

### MORE DETAILED DESCRIPTION OF THE INVENTION

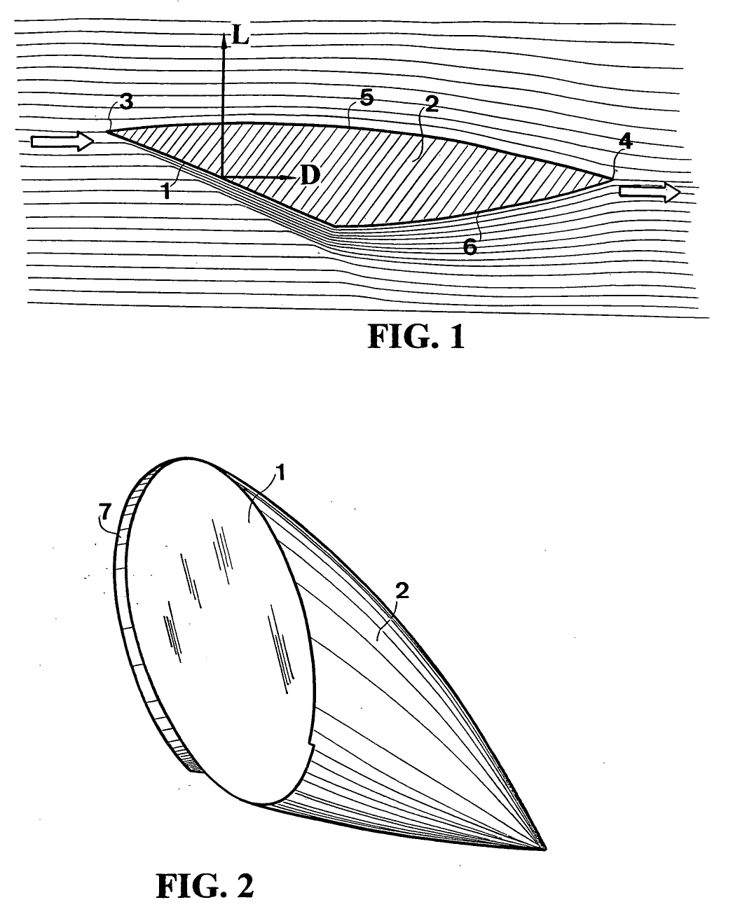

FIG. 1 consists of the front surface inclined with a positive angle (1), generating of the totality or greater part of the lift, the rear portion (2) to the front surface, formed by the two surfaces, the upper (5) and the lower (6), profiled or streamlined, formed by two curve surfaces, which does not generate lift, but leads the air flow properly reducing drag and avoiding that the boundary layer separation takes place. The flow and the arrows show the displacement backwards and downward of the streamlines and as a result the forces generated on the fuselage, where L is the lift and D the drag. The leading edge or nose (3), the trailing edge or tail (4). It is an arrangement with an angle of attack zero.

FIG. 2 consists of the front surface curved and inclined of circular cross-section type with a positive angle of attack (1), generating of the totality or greater part of the lift, the rear portion to the front surface (2) in this case of conical form with its generatrices curved and convex and the flange (7).

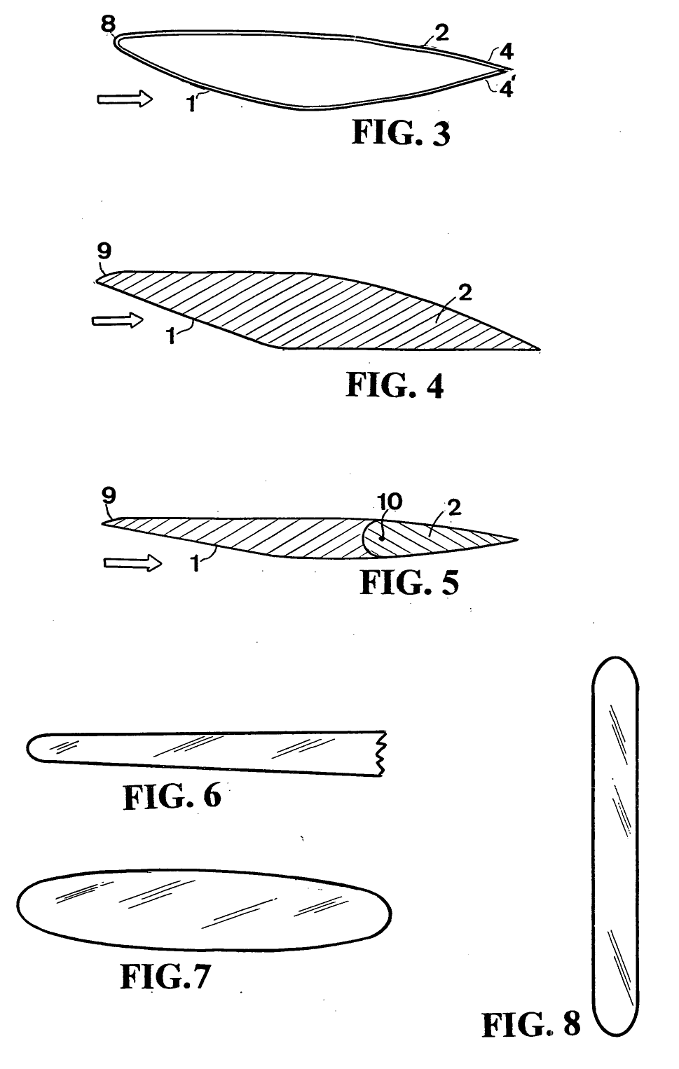

FIG. 3 consists of the inclined front surface, curved and with a positive angle (1), the rear portion to the front surface (2) formed by two sliding plates flexible plates which slide between themselves (4 and 4′) in the trailing edge and the nose or round leading edge (8).

FIG. 4 consists of the inclined front surface (1), the rear portion to the frontal surface (2) and the curve upper zone of the nose or leading edge (9).

FIG. 5 consists of the inclined front surface (1), the rear portion to the frontal surface (2) rotary around the axis (10) and the upper zone of the curved leading edge (9).

FIG. 6 shows the front zone of a portion of a wing of the horizontal form.

FIG. 7 shows the front zone of a profile of oval and horizontal form.

FIG. 8 shows the front zone of a profile of the rectangular and vertical form with rounded corners.

1. An aerodynamic profile, comprising;
a first zone on a front surface of said profile, wherein said first zone is inclined at a positive angle to generate lift;
a second zone on a rear surface adjacent to said front surface, wherein said second zone is faired or streamlined, formed by at least two surfaces, and hollow, which does not generate lift; and
wherein said profile reduces drag and substantially reduces separation of the boundary layer.

2. An aerodynamic profile according to claim 1, wherein said second zone has two convex surfaces.

3. An aerodynamic profile according to claim 1, wherein said second zone to said first zone has a flat lower surface that is rigid, and a curved upper surface.

4. An aerodynamic profile according to claim 1, wherein a periphery of said first zone includes a small projecting flange.

5 (Cancelled).

6. An aerodynamic profile according to claim 1, wherein said profile is arranged longitudinally.

7. An aerodynamic profile according to claim 1, wherein said profile is arranged at an incline.

8. An aerodynamic profile according to claim 1, wherein said second zone is rigid.

9. An aerodynamic profile according to claim 1, wherein said second zone is flexible.

10 (Cancelled).

11. An aerodynamic profile according to claim 1, wherein said second zone is at least partially free and rotary.

12. An aerodynamic profile according to claim 11, wherein said second zone is driven by a ram.

13. An aerodynamic profile according to claim 1, wherein said first zone is flat

14. An aerodynamic profile according to claim 1, wherein said first zone is curve.

15. An aerodynamic profile according to claim 1, wherein an upper zone of the nose or leading edge is curved.

16. An aerodynamic profile according to claim 1, wherein an upper zone of the nose or leading edge is rounded.

17. An aerodynamic profile according to claim 1, wherein said first zone is circular.

18. An aerodynamic profile according to claim 1, wherein said first zone is oval.

19. An aerodynamic profile according to claim 1, wherein said first zone is rectangular with rounded corners rounded.
